(19) United States
(12) Patent Application Publication
(10) Pub. No.: US 2004/0019849 A1
(43) Pub. Date: Jan. 29, 2004

(54) Method and system for providing online web page editing

(76) Inventors: Jen-Hwang Weng, Jungli City (TW); Jung-Sheng Lin, Kaohsiung (TW); Shu-Chun Liu, Jungli City (TW); Po-Chao Huang, Jungli City (TW)

Correspondence Address: BRUCE H. TROXELL, SUITE 1404, 5205 LEESBURG PIKE, FALLS CHURCH, VA, 22041, US

(21) Appl. No.: 10/620,345

(22) Filed: Jul. 17, 2003

(30) Foreign Application Priority Data
Jul. 19, 2002 (TW) 91116082

(51) Int. Cl. G06F 17/00

(52) U.S. Cl. 715/513

(57) ABSTRACT

A website system for providing on-line webpage edition is disclosed. The website system comprises a central processing unit for responding user's commands of editing the user-end webpage contents, such as selecting, saving, and displaying webpage contents, via communication interconnection, a communication interface is used to link to the communication interconnection to connect the website system and the user-end system, a memory for saving a text content, a webpage edition means, and a save means. The text content is comprised of an independent text unit and displayed on a webpage at the user-end system by linking identification information of the independent text unit via the communication interface. The webpage edition means can be downloaded to the user-end system for an user to edit the webpage. The webpage edition means comprises a cursor tool for moving a cursor and a word editor for editing the text and spontaneously displaying the text at the cursor's position. The text works as an independent text unit with identification information. The save means can also be downloaded to the user-end system for transferring the independent text unit and its corresponding identification information to the website system via the communication interconnection and saving them to the text content.

### FIELD OF THE INVENTION

The present invention relates to a computer method and system for providing on-line webpage edition and, more particularly, to a method and system for editing the webpage contents directly on the webpage.

### BACKGROUND OF THE INVENTION

For the large progress of the communication interconnection and webpage browsers, a webpage on the communication interconnection can be viewed anywhere in the world. However, on the other hand, the creation and edition of the webpage contents can only be performed locally at a specific place. For this reason, the present invention provides a method and a system to enable an user to edit the webpage contents on-line, by using webpage browser as the editor via communication interface to perform the edition process.

Due to the present invention uses the webpage browser as the editor, the following advantages can be obtained. The webpage browser is so popular, so it is very easy to be obtained. Moreover, because all webpages use HTML language, to edit the webpage contents on-line can directly display the results without any transformation. In addition, the annotation functions enable the reader to non-linearly inquire the annotation contents.

Comparing to the other professional tools, the present invention provides a user-friendly environment for an user to edit the webpage contents on-line. It is not necessary for an user to have the coding capability like the cases in the prior arts. Only basic typing capability is needed for an user to use the system disclosed in the present invention.

The main differences between the present invention and the other webpage editors in the prior arts are shown as follows:

1. The other webpage editors (prior arts) have the following features:

(1) Almost of the other webpages editors are pay software. There is always a large obstacle for the pay software to be popular.

(2) The other webpage editors need to be installed at the user-end system. For this reason, the editors can only be used at a specific machine.

(3) According to the other webpage editors, the webpage contents cannot be edited directly on the webpage, and a preview function is needed to display the edited webpage contents.

(4) According to the other webpage editors, the webpage contents can be edited in the off-line condition, and then saved and transferred to the website and thus published. If the published webpage is not satisfied, the webpage should be edited again in the off-line condition and then published again. The repetition always wastes users' time and enhances users' costs.

(5) According to the other webpage editors, if a word on the webpage needs to be annotated, it is necessary for the user to create another annotation file which needs to be hyperlinked to the webpage. The hyperlink sign on the webpage will destroy the webpage's appearance.

(6) The other webpage editors cannot enable an user to edit an annotation for specific contents.

(7) According to the other webpage editors, the webpage contents can only be edited in the off-line condition, and then saved and transferred to the website and published. If the webpage is provided by website's servers, the edited webpage cannot be previewed in the edition process. The edited webpage can be viewed only when it is transferred to the website and published. If the published webpage is not satisfied, the webpage should be edited again in the off-line condition and then published again.

2. On the other hand, the present invention has the following features:

(1) Due to the present invention uses the webpage browser as the editor, its popularity and free of expense will largely enhance the users' motivation to use the present invention.

(2) Due to the present invention uses the webpage browser as the editor, additional installation is not needed. The users can edit the webpage contents at any time and at any place.

(3) According to the present invention, the users can edit their webpages on-line, and the edited contents can be displayed spontaneously on the webpages. For this reason, the preview procedure is not needed.

(4) Because the edited contents can be displayed spontaneously on the webpage, the above-mentioned repetition is not needed.

(5) According to the present invention, if a word on the webpage needs to be annotated, it is not necessary for the user to create another annotation file which needs to be hyperlinked to the webpage. According to the present invention, the edited annotation contents can be automatically linked to the webpage, and inquired later through the linkage.

(6) According to the present invention, if a specific content on the webpage needs to be annotated, it is not necessary for the user to create another annotation file which needs to be hyperlinked to the webpage. According to the present invention, the edited annotation contents can be automatically linked to the webpage, and inquired later through the linkage.

(7) According to the present invention, the webpages are edited at the user-end system without connecting to the website servers. The above-mentioned repetition is not needed.

Besides, due to all webpages use HTML language, to edit the webpage contents on-line in the present invention can directly display the results without any transformation. For this reason, the integration application of the webpage browser interface and the edition interface is very important.

### SUMMARY OF THE INVENTION

The main purpose of the present invention is to provide a system and a method for editing webpages on-line. The users can edit the webpage contents on-line at any time and at any place.

According to the method of the present invention, a function to enable an user to edit webpage on-line is provided through the interface of the webpage browser. The users can write and edit their works on-line, such as inserting words, inserting pictures or voices, breaking lines, indenting contents, and so on. In other word, the edited contents can be directly displayed on the webpage without any interface. For example, an user can insert a word directly on the webpage, and the inserted word can be displayed on the webpage spontaneously.

The edited contents of an user would be divided into text contents and annotation contents. Each text content is considered as an independent text unit and given a kind of identification information. Annotation contents are the relevant annotation of some specific words or units of the text contents. Each annotation is linked to its corresponding word or specific content for later inquiry. The linkage could be performed by means of linking function provided by a database library.

According to the method of providing on-line webpage edition, the following processes are disclosed.

1. Displaying a Webpage for Writing:

An user logs-in the website system via the network, and a webpage is provided by the website system for the user to edit it on-line.

2. Editing the Webpage:

The webpage edition means can be downloaded to the user-end system for an user to edit the webpage. The webpage edition means comprises a cursor tool and a word editor. The cursor tool is applied to move the cursor, and the word editor is applied to edit the text contents at the cursor's position. Each edited webpage content serves as an independent text unit with identification information.

3. Saving Edited Contents:

The save means can also be downloaded to the user-end system for transferring the independent text unit and its corresponding identification information to the website system via the communication interconnection and saving them to the text contents.

Actually, it is not necessary for the present invention to edit the webpage contents on-line. Even in the off-line case, all webpages stored in the container can be edited by the webpage edition means, and saved to the webpage file by the saving means provided by the container. The only one difference is that the edited webpage contents need not be saved back to the server during the off-line edition processes. At this time, the edited webpage contents are saved just at the user-end system.

At step 1, the container is a webpage browser or a webpage edition software,

At step 2, the webpage edition means further comprises a file-inserting tool, a webpage-object-inserting tool, a line-breaking tool, an indentation tool, an eraser tool, and a clipboard tool. The cursor tool is applied to move the cursor, and the word editor is applied to edit the text contents at the cursor's position. The file-inserting tool is applied to add or delete a file at the cursor's position. The webpage-object-inserting tool is applied to add or delete a webpage object at cursor's position. The line-breaking tool is applied for the user to move the cursor to the other line. The indentation tool is applied to indent the webpage contents at cursor's position. The eraser tool is applied to delete selected contents on the webpage. The clipboard tool is applied to copy text contents on the webpage, and paste the copied contents to other positions. The key feature of the present invention is that all processes mentioned above are performed directed on the webpage, and the results are displayed on the webpage spontaneously.

The container further provides an annotation means which comprises a word annotation tool, in order to enable an user to create an annotation contents for a selected word on the webpage. When an user selects a word to edit its annotation, an annotation edition area will be created on the webpage in order to enable the user to edit the annotation contents by means of webpage edition means. When the user finishes editing, the annotation edition area will disappear, and the edited annotation contents, the word, and its corresponding identification information are stored temporarily on the webpage. Thereafter, the edited annotation contents, the word, and its corresponding identification information will be transferred back to the website system and stored at the memory to be annotation contents.

The container further provides an annotation means which comprises a unit annotation tool. The unit annotation tool has to be downloaded to the user-end system, in order to enable an user to edit the annotation of a specific content on the webpage, and to divide the webpage into a number of independent text units. The specific content would be one of the independent text units. For example, if the specific content is the middle part of the webpage, the beginning part and the end part of the webpage will also be set to independent text units. In other word, the original webpage is divided into three parts. When an user selects a specific content to edit its annotation, an annotation edition area will be created on the webpage in order to enable the user to edit the annotation contents by means of webpage edition means. When the user finishes editing, the annotation edition area will disappear, and the edited annotation contents, the specific content, and its corresponding identification information are stored temporarily on the webpage. Thereafter, the edited annotation contents, the specific content, and its corresponding identification information will be transferred back to the website system and stored at the memory to be annotation contents. At this time, due to the webpage has been divided into several independent text units, all the independent text units and their renewed corresponding identification information are also temporarily stored on the webpage. If there is a word annotation on the webpage, the identification information of its independent text unit will also be renewed and temporarily stored on the webpage. Consequently, all independent text units and their corresponding identification information will also be transferred back to the website system and stored at the memory to be annotation contents.

An inquiry means is also provided in the present invention for inquiring existed annotation contents and displaying them. The inquiry means can also be downloaded to the user-end system for an user to inquire existed unit annotation contents and display them on said webpage. If a selected word has an existed annotation with annotation contents, the inquiry means can be applied to display the annotation contents on the webpage according to word and the identification information of the independent text unit. If a selected independent text unit has an existed annotation with annotation contents, the inquiry means can be applied to display the annotation contents on the webpage according to the unit and the identification information of the independent text unit.

According to the method mentioned above, when all text contents and annotation contents are displayed on the webpage, they are temporarily stored at a pre-determined container, such as FONT object.

A user-end website system for providing on-line webpage edition is also disclosed in the present invention. The website system at least comprises a central processing unit, a communication interface, a memory, a webpage edition means, and a save means.

Said central processing unit is to respond user-end's commands of editing user-end webpage contents, such as selecting, saving, and displaying webpage contents, via communication interconnection.

Said communication interface is used to link to the communication interconnection to connect the website system and said user-end system.

The text contents is comprised of an independent text unit and displayed on a webpage at a user-end system by linking identification information of the independent text unit via the communication interface. The webpage edition means can be downloaded to the user-end system for an user to edit the webpage. The webpage edition means comprises a cursor tool for moving a cursor and a word editor for editing and spontaneously displaying text at the cursor's position. The text works as an independent text unit with identification information. The save means can also be downloaded to the user-end system for transferring the independent text unit and its corresponding identification information to the website system via the communication interconnection and saving them to the text contents.

The memory stores at least the text contents. The text contents comprise at least an independent text unit, which can be displayed on a webpage by connecting its corresponding identification information via communication interface.

The webpage edition means can be downloaded to the user-end system for an user to edit the webpage. The webpage edition means at least comprises a cursor tool, a word editor, a file-inserting tool, a webpage-object-inserting tool, a line-breaking tool, an indentation tool, an eraser tool, and a clipboard tool. The cursor tool is applied to move the cursor, and the word editor is applied to edit the text at the cursor's position. The file-inserting tool is applied to add or delete a file at the cursor's position. The webpage-object-inserting tool is applied to add or delete a webpage object at cursor's position. The line-breaking tool is applied to move the cursor to next line. The indentation tool is applied to indent the webpage contents at cursor's position. The eraser tool is applied to delete selected contents on the webpage. The clipboard tool is applied to copy text on the webpage, and paste the copied contents to cursor's positions. The edited webpage contents serve as an independent text unit with identification information.

The save means can also be downloaded to the user-end system for said user to transfer the independent text unit and its corresponding identification information to the website system via the communication interconnection and the central processing unit save them to the text contents of the memory.

In addition, the website system further comprises an annotation means, which comprises a word annotation tool. The word annotation tool has to be downloaded to the user-end system, in order to enable an user to edit the annotation of a word on the webpage, and to temporarily save the annotation content on the webpage. When an user selects a word to edit its annotation, an annotation edition area will be created on the webpage in order to enable the user to edit the annotation contents by means of webpage edition means. When the user finishes editing, the annotation edition area will disappear, and the edited annotation contents, the word, and its corresponding identification information are stored temporarily on the webpage. Thereafter, the edited annotation contents, the word, and its corresponding identification information will be transferred back to the website system and the central processing unit stored them at the memory of the website system to be annotation contents.

The annotation means further comprises a unit annotation tool. The unit annotation tool has to be downloaded to the user-end system, in order to enable an user to edit the annotation of a specific content on the webpage, and to divide the webpage into a number of independent text units.

The specific content would be one of the independent text units. For example, if the specific content is the middle part of the webpage, the beginning part and the end part of the webpage will also be set to an independent text unit. In other word, the original webpage is divided into three parts.

When an user selects a specific content to edit its annotation, an annotation edition area will be created on the webpage in order to enable the user to edit the annotation contents by means of webpage edition means. When the user finishes editing, the annotation edition area will disappear, and the edited annotation contents, the specific content, and its corresponding identification information are stored temporarily on the webpage. Thereafter, the edited annotation contents, the specific content, and its corresponding identification information will be transferred back to the website system and stored at the memory to be annotation contents. At this time, due to the webpage has been divided into several independent text unit, all the independent text units and their new corresponding identification information are also temporarily stored on the webpage. If there is a word annotation on the webpage, the identification information of its independent text unit will also be renewed and temporarily stored on the webpage. Consequently, all independent text units and their corresponding identification information will also be transferred back to the website system and stored at the memory of the website system to be annotation contents.

The website system further comprises an inquiry means. The inquiry means can also be downloaded to the user-end system for an user to inquire existed unit annotation contents and display them on the webpage. If a selected word has an existed annotation with annotation contents, the inquiry means can be applied to display the annotation contents on the webpage according to the word and the identification information of the independent text unit. If a selected independent text unit has an existed annotation with annotation contents, the inquiry means can be applied to display the annotation contents on the webpage according to the unit and the identification information of the independent text unit.

### BRIEF DESCRIPTION OF THE DRAWINGS

FIG. 1 schematically shows the system diagram in accordance with the present invention.

FIG. 2 is an embodiment of the block diagram of the website system according to the present invention.

FIG. 3 is a flow diagram of providing an user to edit webpage contents on-line in one embodiment of the present invention.

FIG. 4 is a flow diagram of providing an user to edit word annotation contents on-line in one embodiment of the present invention.

FIG. 5 is a flow diagram of providing an user to edit unit annotation contents on-line in one embodiment of the present invention.

FIG. 6 is a flow diagram of providing an user to edit annotation contents on-line in one embodiment of the present invention.

### DESCRIPTION OF THE PREFERRED EMBODIMENT

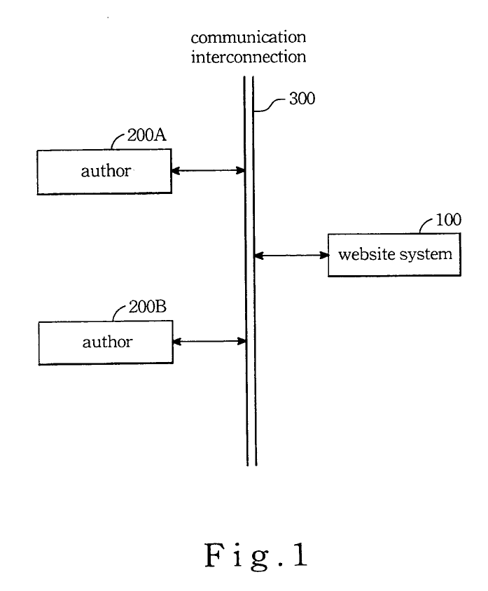

The system diagram in accordance with the present invention is schematically shown in FIG. 1. A plurality of users 200 can log-in the website system 100 via communication interconnection 300 (such as network) for writing and editing on-line.

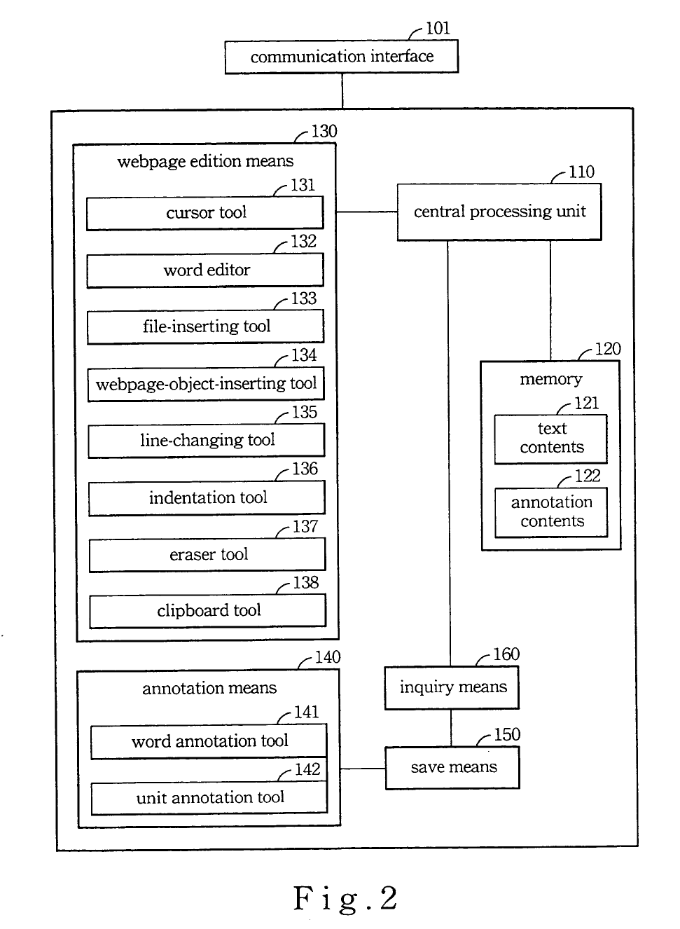

Referring now to FIG. 2, an embodiment of the block diagram of the website system according to the present invention is shown as follows:

website system 100;

communication interface 101: for connecting to the communication interconnection 300 to connect website system 100 and user-end system 200;

central processing unit 110: for responding user-end's commands of editing user-end webpage contents, such as selecting, saving, and displaying webpage contents, via communication interconnection;

memory 120: containing text contents 121 and annotation contents 122∘

Text Contents 121:

The text content 121 is the text edited by users 200, who can edit webpage contents directly using webpage edition means 130. The edited webpage content is considered as an independent text unit and given a kind of identification information (such as a chapter, a section, a paragraph, a sentence or a file name). After editing, the independent text unit and the identification information are transferred to the website system 100 by using the save means 150, and saved to the text contents 121 of the memory 120. After that, the independent text unit can be displayed on a webpage by connecting its corresponding identification information.

Annotation Contents 122:

Annotation contents 122 are the relevant annotation of some specific words or units of the text contents. The annotation contents 122 are consisted of word annotation contents and unit annotation contents. The annotation contents can be edited by users 200 by selecting words on the webpage and using the word annotation tool 141 and the webpage edition means 130. At this time, the annotation contents, the words, and their corresponding identification informations are saved temporary on the webpages. Alternatively, the annotation contents can also be edited by selecting specific texts on the webpage and then using the unit annotation tool 142 and the webpage edition means 130. At this time, the specific text works as an independent text unit, and the annotation contents and their corresponding identification information are saved temporary on the webpages. Finally, the temporary-saved annotation contents are transferred to the website system 100 by the save means 150, and saved on the annotation contents 122 of the memory 120.

Webpage Edition Means 130:

Cursor 131:

It is well-known that the cursor can be moved on the webpage by operating a mouse or a keyboard. Generally, the cursor is displayed on the webpage as a cursor diagram. While setting the identification information of the cursor diagram as “CursorPic”, the operation procedure will be shown as follows:

1. Setting the Coordination of the Cursor by One-Clicking the Webpage:

While one-clicking the webpage and stimulating a MouseDown event, its corresponding coordination (x,y) will be obtained and a TextRange object will be created on the webpage. The TextRange object is denominated as CursorRange, and moved to the coordination (x,y) by using the method of MoveToPoint. Its attribute value of OffsetLeft and OffsetTop will then be obtained. As soon as the following settings are performed, the cursor diagram will be moved to the clicking position.

CursorPic.PosLeft=CursorRnage.OffsetLeft+ScrollLeft

CursorPic.PosTop=CursorRnage.OffsetTop+ScrollTop

2. By Cursor-Movement Keys:

While one cursor-movement key is pressed, a KeyDown event will be stimulated, and the cursor will be moved according to the recognition of KeyCode. The procedure is shown as follows:

(1) Pressing the Left/Right-Moving Keys:

While the left-moving key or the right-moving key is pressed, the cursor will be moved leftward or rightward to a character. CursorRange will be moved to the coordination (x,y) by using the method of MoveToPoint. Its attribute value of OffsetLeft and OffsetTop will then be obtained.

(2) Pressing the Up-Moving Keys:

While the left-moving key keeps pressed, the cursor will be moved leftward to a character continuing. A character (CursorRange.expand) is selected for each movement to judge whether Chr(10) and Chr(13) are met. When it is positive, it means that the cursor is moved to the beginning of a line. The cursor will be moved upward while the left-moving key is pressed. At this time, a new coordination will be set by combining the OffsetTop of CursorRange and the X coordination of the original cursor position.

(3) Pressing the Down-Moving Keys:

While the right-moving key keeps pressed, the cursor will be moved rightward to a character continuing. A character (CursorRange.expand) is selected for each movement to judge whether Chr(10) and Chr(13) are met. When it is positive, it means that the cursor is moved to the end of a line. The cursor will be moved downward while the right-moving key is pressed. At this time, a new coordination will be set by combining the OffsetTop of CursorRange and the X coordination of the original cursor position.

Word Editor 132:

The word editor 132 works to instantaneously display the added or deleted word at the cursor's position on the webpage. The operation procedure is disclosed as follows:

(1) Adding Characters:

While the cursor is moved to the predetermined position by the cursor tool 131, the CursorRange object will be created. A word-input-frame will be created at the cursor's position with a height of a word-line and a width of zero. The width of the word-input-frame will be widened as soon as an user 200 inputs characters. The characters input by the user 200 will be displayed immediately on the webpage. When the user 200 finishes inputting, the character in the word-input-frame will be pasted at the cursor's position on the webpage by means of CursorRange.PasteHTML.

(2) Deleting Characters:

When the user 200 presses the Delete key, a KeyDown event will be detected. The CursorRange is expanded rightward to a character, and CursorRange.selection.clear is set. The same function can be obtained by pressing the Backspace key.

File-Inserting Tool 133:

By using the file-inserting tool 133, any picture, sound, or multimedia file can be added or deleted by the user 200, and spontaneously displayed at the cursor's position on the webpage. An example is disclosed as follows for inserting or deleting a picture file.

1. Inserting a Picture File:

The cursor is moved by the cursor tool 131, and the CursorRange object is created. An INPUT object is then input on the webpage, and its attribute value of TYPE is set to FILE. The user 200 is enabled to browse the file catalogue and to select picture files. The selected file is then uploaded to a predetermined position of the website system 100 via a browser such as IE. At the same time, an IMG object is pasted at the cursor's position on the webpage by means of CursorRange.PasteHTML. The attribute value of SRC of the IMG object is set to the entity path of the picture file at the user's computer. When the user finishes editing or the webpage is re-arranged, the attribute value of SRC of the IMG object is then set to the predetermined position of the website system 100 to display the picture on the webpage.

2. Deleting a Picture File:

While deleting a picture file, the identification information of the picture file is obtained, and the OuterHTML is set to be null. The file name of the picture file is then transferred back to the website system 100 by means of “Remote Data Service” of IE or the like, and finally the picture file is deleted.

Webpage-Object-Inserting Tool 134:

The webpage-object-inserting tool 134 could be used to insert (or delete) and display webpage objects directly at the cursor's position. Some examples of the webpage objects are tables, frames, or hyperlinks. The examples to insert and delete a table object are shown as follows:

1. Inserting a Table:

While the cursor is moved by the user 200 by means of the cursor tool 131, the position to insert a table object is determined and the CursorRange object is created. While the user 200 requests to insert a table, a dialogue interface is provided for the user 200 to select the attribute of the table. In accordance with its attribute, the corresponding HTML codes are obtained and pasted at the cursor's position to display the new-added table by means of CursorRange.PasteHTML.

2. Deleting a Table:

When a table is selected to be deleted, the identification information of the table will be obtained, and the table will be deleted after setting OuterHTML of the table to be null.

Line-Breaking Tool 135:

When the line-breaking tool button or Enter button is pressed, the cursor on the webpage will be moved to the next line and the result will be displayed immediately. During this process, the cursor is first moved to a designated position by moving the cursor tool 131, and CursorRange object is then created. When the Enter button is pressed, “<BR>” will be pasted at the cursor's position by means of CursorRange.PasteHTML, and the cursor will be moved to the next line immediately.

Indentation Tool 136:

When the indentation tool button, the Tab button, or the Space button is pressed, the webpage contents at the cursor's position will be indented spontaneously. In the case of pressing the Tab button, the cursor is first moved to a designated position by moving the cursor tool 131, and CursorRange object is then created. When the Tab button is pressed, “&nbsp;” will be pasted at the cursor's position by means of CursorRange.PasteHTML, and the webpage contents at the cursor's position will be indented spontaneously.

Eraser Tool 137:

The eraser tool 137 is applied to directly delete selected contents on the webpage. When a specific content on the webpage is selected, a TextRange object is spontaneously created on the webpage by means of selection.createRange, and denominated to be SelRange. According to the parentElement of SelRange, the innerHTML of the parent element of SelRange will be obtained, and SelRange.HTMLText will be deleted from SelRange.parentElement.innerHTML. Consequently, the selected contents on the webpage is deleted.

Clipboard Tool 138:

The clipboard tool 138 is applied to copy a selected content on the webpage, or to paste the copied content to the webpage at the cursor's position and display the result spontaneously.

When a specific content on the webpage is selected to be copied, a TextRange object is spontaneously created on the webpage by means of selection.createRange, and denominated to be SelRange. The selected content is then copied to the clipboard by means of clipboardData.setData(“text”, SelRange.text). The position to paste the selected content can be determined by moving the cursor using the cursor tool 131, and then CursorRange object is created. The content stored in the clipboard is thus pasted on the webpage at the cursor' position by means of CursorRange.PasteHTML clipboardData.getData(“text”).

Annotation Means 140:

Word Annotation tool 141:

The word annotation tool 141 has to be downloaded to the user-end system, in order to enable an user 200 to edit the annotation of a word on the webpage, and to temporarily save the annotation content on the webpage. When an user 200 selects a word to edit its annotation, an annotation edition area will be created on the webpage in order to enable the user to edit the annotation contents by means of webpage edition means 130. When the user finishes editing, the annotation edition area will disappear, and the edited annotation contents, the word, and its corresponding identification information are stored temporarily on the webpage. Thereafter, the edited annotation contents, the word, and its corresponding identification information will be transferred back to the website system 100 and stored at the memory 120 to be annotation contents 122.

Unit Annotation Tool 142:

The unit annotation tool 142 has to be downloaded to the user-end system also, in order to enable an user 200 to edit the annotation of a specific content on the webpage, and to divide the webpage into a number of independent text units. The specific content would be one of the independent text units. For example, if the specific content is the middle part of the webpage, the beginning part and the end part of the webpage will also be set to an independent text unit. In other word, the original webpage is divided into three parts.

When an user 200 selects a specific content to edit its annotation, an annotation edition area will be created on the webpage in order to enable the user to edit the annotation contents by means of webpage edition means 130. When the user finishes editing, the annotation edition area will disappear, and the edited annotation contents, the specific content, and its corresponding identification information are stored temporarily on the webpage. Thereafter, the edited annotation contents, the specific content, and its corresponding identification information will be transferred back to the website system 100 and stored at the memory 120 to be annotation contents 122. At this time, due to the webpage has been divided into several independent text unit, all the independent text units and their new corresponding identification information are also temporarily stored on the webpage. If there is a word annotation on the webpage, the identification information of its independent text unit will also be renewed and temporarily stored on the webpage. Consequently, all independent text units and their corresponding identification informations will also be transferred back to the website system 100 and stored at the memory 120 to be annotation contents 122.

Save Means 150:

The save means 150 can also be downloaded to the user-end system for an user 200 to transfer the independent text unit and its corresponding identification information to the memory 120 of the website system 100 via the communication interconnection 300 and save them to the text contents 121. On the other hand, the edited annotation is saved to annotation contents 122. If a word annotation is edited, what are saved are the word, and word annotation contents and their corresponding identification information; if an unit annotation content is edited, what are saved are the annotation contents and their corresponding identification information. One example of the save means 150 is “Remote Data Service” of IE.

Inquiry Means 160:

The inquiry means can also be downloaded to the user-end system for an user 200 to inquire existed unit annotation contents and display them on the webpage. If a selected word has an existed annotation with annotation contents, the inquiry means can be applied to display the annotation contents on the webpage according to word and the identification information of the independent text unit. If a selected independent text unit has an existed annotation with annotation contents, the inquiry means can be applied to display the annotation contents on the webpage according to the unit and the identification information of the independent text unit.

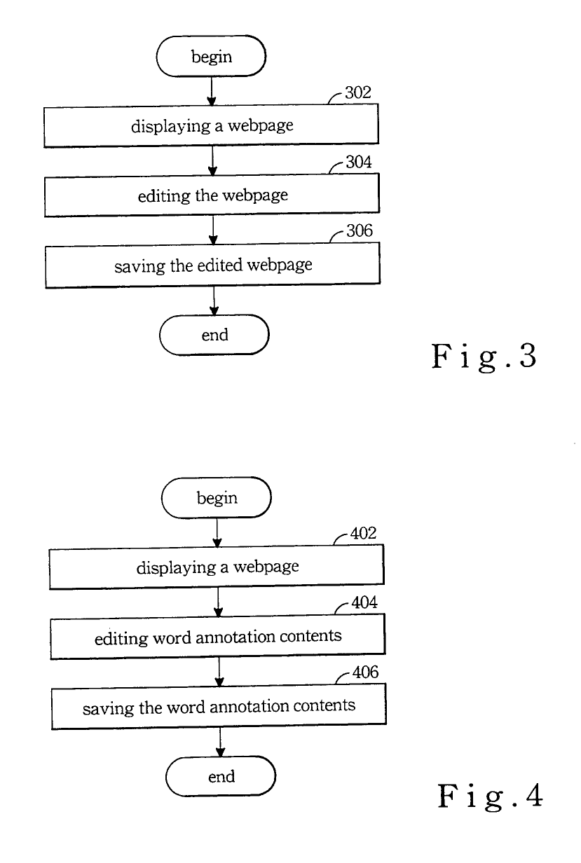

FIG. 3 is a flow diagram of providing an user to edit webpage contents on-line in one embodiment of the present invention.

1. Displaying a Webpage for Writing:

An user 200 logs-in the website system 100 via the communication interconnection 300, and a webpage is provided by the website system 100 for the user 200 to write on-line. If the user 200 logs-in the website system 100 for the first time, the webpage would be empty. Otherwise, the independent text units from the text contents 121 are displayed on the webpage by using their corresponding identification information (step 302).

2. Editing the Webpage:

The webpage edition means 130 can be downloaded to the user-end system for an user to edit the webpage. The webpage edition means 130 comprises a cursor tool 131, a word editor 132, a file-inserting tool 133, a webpage-object-inserting tool 134, a line-breaking tool 135, an indentation tool 136, an eraser tool 137, and a clipboard tool 138. The cursor tool 131 is applied to move the cursor, and the word editor 132 is applied to edit the text contents at the cursor's position. The file-inserting tool 133 is applied to insert or delete a file at the cursor's position. The webpage-object-inserting tool 134 is applied to insert or delete a webpage object at cursor's position. The line-breaking tool 135 is applied to move the cursor to the other line. The indentation tool 136 is applied to indent the webpage contents at the cursor's position. The eraser tool 137 is applied to delete selected contents on the webpage. The clipboard tool 138 is applied to copy text contents on the webpage, and paste the copied contents to other positions. Each edited webpage content serves as an independent text unit with identification information (step 304).

3. Saving Edited Contents:

The save means 150 can also be downloaded to the user-end system for transferring the independent text unit and its corresponding identification information to the website system 100 via the communication interconnection 300 and saving them to the text contents 121, which use the identification information 300 as the file name (step 306).

FIG. 4 is a flow diagram of providing an user to edit word annotation contents on-line in one embodiment of the present invention.

1. Displaying a Webpage for Writing:

An user 200 logs-in the website system 100 via the network 300, and a webpage is provided by the website system 100 for the user 200 to write on-line. The independent text units from the text contents 121 are displayed on the webpage by using their corresponding identification information (step 402).

2. Editing the Word Annotation Contents:

The annotation means 140 comprising a word annotation tool 141 can be downloaded to the user-end system for an user to edit the webpage. When an user 200 selects a word to edit its annotation, an annotation edition area will be created on the webpage in order to enable the user to edit the annotation contents by means of webpage edition means 130. When the user finishes editing, the annotation edition area will disappear, and the edited annotation contents, the word, and its corresponding identification information are stored temporarily on the webpage (step 404).

3. Saving Edited Contents:

The save means 150 can also be downloaded to the user-end system for transferring the edited annotation contents, the word, and its corresponding identification information to the website system 100 via the communication interconnection 300 and saving them to the annotation contents 122 (step 406).

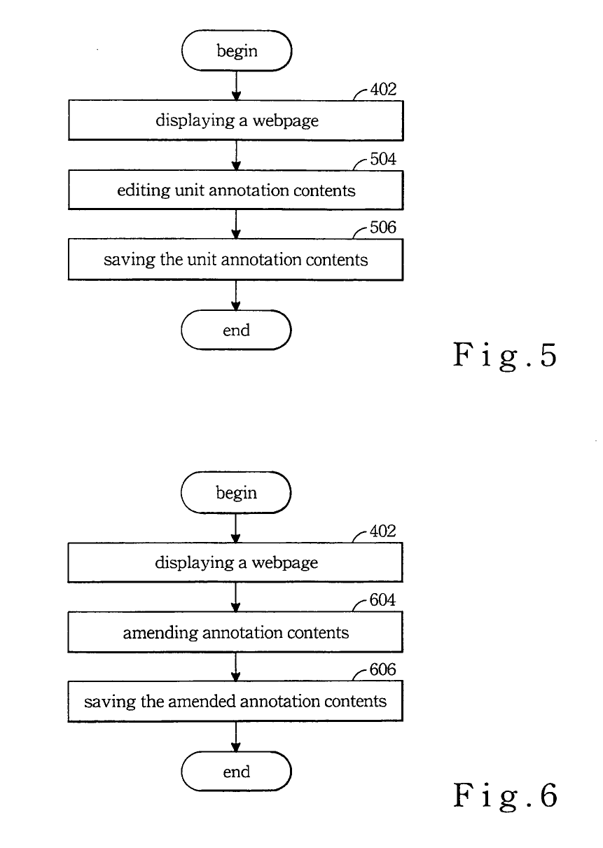

FIG. 5 is a flow diagram of providing an user to edit unit annotation contents on-line in one embodiment of the present invention.

1. Displaying a Webpage for Writing:

An user 200 logs-in the website system 100 via the network 300, and a webpage is provided by the website system 100 for the user 200 to write on-line. The independent text units from the text contents 121 are displayed on the webpage by using their corresponding identification information (step 502).

2. Editing the Word Annotation Contents:

The annotation means 140 comprising a unit annotation tool 142 can be downloaded to the user-end system for an user to edit the webpage. When an user 200 selects a specific content to edit its annotation, an annotation edition area will be created on the webpage in order to enable the user to edit the annotation contents by means of webpage edition means 130. When the user finishes editing, the annotation edition area will disappear, and the edited annotation contents, the specific content, and its corresponding identification information are stored temporarily on the webpage. At this time, due to the webpage has been divided into several independent text unit, all the independent text units and their new corresponding identification information are also temporarily stored on the webpage. (step 504).

3. Saving Edited Contents:

The save means 150 can also be downloaded to the user-end system. The save means 150 is applied to transfer all independent text units and their corresponding identification information back to the website system 100 and save them at the memory 120 to be text contents 121. At the same time, annotation contents 122 are renewed by transferring the identification information of the word's independent text unit to the website system 100. In addition, the unit annotation contents and their corresponding identification information are also transferred back to the website system 100 and saved to the annotation contents 122 (step 506).

FIG. 6 is a flow diagram of providing an user to edit annotation contents on-line in one embodiment of the present invention.

1. Displaying a Webpage for Writing:

An user 200 logs-in the website system 100 via the network 300, and a webpage is provided by the website system 100 for the user 200 to write on-line. The independent text units from the text contents 121 are displayed on the webpage by using their corresponding identification information (step 602).

2. Editing the Annotation Contents:

The inquiry means can also be downloaded to the user-end system for an user 200 to inquire existed unit annotation contents and display them on the webpage. If a selected word has an existed annotation with annotation contents, the inquiry means can be applied to display the annotation contents on the webpage according to word and the identification information of the independent text unit. If a selected independent text unit has an existed annotation with annotation contents, the inquiry means can be applied to display the annotation contents on the webpage according to the unit and the identification information of the independent text unit. When an existed annotation contents are inquired by the user 200, the annotation contents can be directly edited on-line by means of the webpage edition means 130. After editing, the edited annotation contents are temporarily stored on the webpage (step 604).

3. Saving Edited Contents:

The save means 150 can also be downloaded to the user-end system for transferring the edited annotation contents back to the website system 100 via the communication interconnection 300 and saving them to the annotation contents 122 (step 606).

Although the present invention has been described in terms of specific exemplary embodiments, it will be appreciated that various modifications and alterations might be made by those skilled in the art without departing from the spirit and scope of the invention as set forth in the following claims.

We claim:

1. A method for editing a webpage, at least comprising:
displaying a webpage in a container of a user-end system;
wherein said container provides a webpage edition means which at least comprises a cursor tool and a word editor;
wherein a cursor can be moved by said user by means of said cursor tool, and a text can be edited at a position of said cursor by means of said word editor and directly displayed at
said position on said webpage;
wherein said container provides a save means to save said webpage content at user-end system.

2. The method of claim 1, further comprising:
wherein said webpage is provided by a server via communication interconnection;
wherein said webpage content serves as an independent text unit with identification information;
wherein said save means can transfer said independent text unit and its corresponding identification information to said server via said communication interconnection and save them.

3. The method of claim 1, wherein said container is a browser.

4. The method of claim 1, wherein said container is a webpage editor.

5. The method of claim 1, wherein said webpage edition means further comprises a file-inserting tool, in order to enable said user to add or delete a file at said position on said webpage, and said file is displayed spontaneously at said position.

6. The method of claim 1, wherein said webpage edition means further comprises a webpage-object-inserting tool, in order to enable said user to add or delete a webpage object at said position on said webpage, and said webpage object is displayed spontaneously at said position.

7. The method of claim 1, wherein said webpage edition means further comprises a line-breaking tool, in order to enable said user to move a cursor to next line and display its result spontaneously.

8. The method of claim 1, wherein said webpage edition means further comprises an indentation tool, in order to enable said user to perform indentation at said position, and said indentation is displayed at said position spontaneously.

9. The method of claim 1, wherein said webpage edition means further comprises an eraser tool, in order to enable said user to delete a selected content and display its result spontaneously.

10. The method of claim 1, wherein said webpage edition means further comprises a clipboard tool, in order to enable said user to copy a selected text on said webpage or paste a copied text at said position, and display its result spontaneously.

11. The method of claim 2, further comprising:
wherein said container further provides an annotation means which at least comprises a word annotation tool, in order to enable said user to create an annotation content for a selected word on said webpage, wherein said annotation content can be edited by said webpage edition means, and said selected word, its annotation contents and the identification of the independent text unit of said work would be connected together;
wherein said save means is used to transfer said word, said annotation content, and identification information of the independent text unit of said word to said server via communication interconnection, and to save them.

12. The method of claim 2, further comprising:
wherein said container further provides an annotation means which at least comprises a unit annotation tool, in order to enable said user to create an annotation content for a specific content on said webpage, wherein said annotation content can be edited by said webpage edition means;
wherein said webpage is divided into several independent text units and said specific content is one of them, and said specific content would be connected with its corresponding annotation content; wherein said save means is used to transfer said independent text units and their corresponding identification information to said server via communication interconnection, and to save them;
wherein said save means is also used to transfer said specific content, said annotation contents, and identification information of said specific content to said server via communication interconnection, and to save them.

13. The method of claim 11, wherein said container further provides an inquiry means for said user to inquiry existed word annotation contents and display them on said webpage.

14. The method of claim 12, wherein said container further provides an inquiry means for said user to inquire existed unit annotation contents and display them on said webpage.

15. A website system for providing on-line webpage edition, at least comprising:
a central processing unit for responding user's commands of editing the user-end webpage contents, such as selecting, saving, and displaying webpage contents, via communication interconnection;
a communication interface is used to link to the communication interconnection to connect the website system and said user-end system;
a memory for saving a text content, wherein said text content is comprised at least of an independent text unit and displayed on a webpage at said user-end system;
a webpage edition means, wherein said webpage edition means can be downloaded to said user-end system for said user to edit said webpage; wherein said webpage edition means at least comprises a cursor tool for moving a cursor and a word editor for editing and spontaneously displaying edited text at a cursor's position; said text would be considered as an independent text unit with its corresponding identification information; and
a save means, wherein said save means can also be downloaded to said user-end system for transferring said independent text unit and its corresponding identification information to said website system via said communication interconnection and saving them to said text content.

16. The website system of claim 15, wherein said webpage edition means further comprises an file-inserting tool, in order to enable said user to add or delete a file at said position on said webpage, and said file will be displayed spontaneously at said position.

17. The website system of claim 15, wherein said webpage edition means further comprises a webpage-object-inserting tool, in order to enable said user to add or delete a webpage object at said position on said webpage, and said webpage object will be displayed spontaneously at said position.

18. The website system of claim 15, wherein said webpage edition means further comprises a line-breaking tool, in order to enable said user to move a cursor to next line and display its result spontaneously.

19. The website system of claim 15, wherein said webpage edition means further comprises an indentation tool, in order to enable said user to perform indentation at said position, and said indentation is displayed at said position spontaneously.

20. The website system of claim 15, wherein said webpage edition means further comprises an eraser tool, in order to enable said user to delete a selected content and display its result spontaneously.

21. The website system of claim 15, wherein said webpage edition means further comprises a clipboard tool, in order to enable said user to copy a selected content on said webpage or paste a copied content at said position, and display its result spontaneously.

22. The website system of claim 15, wherein said container further provides an annotation means which comprises a word annotation tool, in order to enable said user to create an annotation content for a selected word on said webpage,
wherein said annotation content can be edited by said webpage edition means;
wherein said save means is used to transfer said word, said annotation content, and identification information of the independent text unit of said word to said website system via communication interconnection, and save them.

23. The website system of claim 15, wherein said container further provides an annotation means which comprises a unit annotation tool, in order to enable said user to create an annotation content for a specific content on said webpage,
wherein said annotation content can be edited by said webpage edition means; wherein said webpage is divided into several independent text units and said specific content is one of them;
wherein said save means is used to transfer said independent text units and their corresponding identification information to said website system via communication interconnection, and to save them;
wherein said save means is also used to transfer said specific content, said annotation contents, and identification information of said specific content to said website system via communication interconnection, and to save them.

24. The website system of claim 22, wherein said container further provides an inquiry means for said user to inquire existed word annotation contents and display them on said webpage.

25. The website system of claim 23, wherein said container further provides an inquiry means for said user to inquire existed unit annotation contents and display them on said webpage.
